(19) United States
(12) Patent Application Publication
(10) Pub. No.: US 2018/0057253 A1
(43) Pub. Date: Mar. 1, 2018

(54) LINER FOR TRASH BIN

(71) Applicant: DeWayne Bates, Norfolk, NE (US)

(72) Inventor: DeWayne Bates, Norfolk, NE (US)

(21) Appl. No.: 15/245,231

(22) Filed: Aug. 24, 2016

(51) Int. Cl. B65F 1/06; B65F 1/14

(52) U.S. Cl. CPC B65F 1/06; B65F 2250/114; B65F 1/141

(57) ABSTRACT

A trash bin with a liner to dump trashes is provided. The trash bin includes (i) a plastic sheet that is adapted to get folded by a user, (ii) a tripod stand holding slot that is adapted to hold a tripod stand, (iii) a plurality of liner holding slots that are adapted to lock the liner, and (iv) a plurality of velcros that are attached to both sides of the plastic sheet. The tripod stand holds the trash bin in upright position. The trash bin is covered by the liner from outside or inside of the trash bin. The plurality of velcros is adapted to form a cylindrical structure by rolling the plastic sheet of the trash bin.

### BACKGROUND

### Technical Field

The embodiments herein generally relate to a trash bin, and, more particularly, a liner for the trash bin.

### Description of the Related Art

Trash containers, typically lined with trash bags, are a ubiquitous means for dealing with waste in public places. In spite of the many advances in waste management systems, fundamental problems remain. For example, liquid waste in bags may leak out, leaving undesirable waste at the bottom of a trash container or elsewhere. Overloaded bags also result in spillage from overflowing waste or from breaks or leaks in the bag, resulting in waste material inside trash containers or on the floor away from the containers when the bags are removed to a dumpster or other location. Liquid on the floor that leaks from a trash bag may result in slipping or other accidents, and waste of any kind that spills from trash bags may result in insect infestations or the growth of unwanted bacteria or other microbes, and may attract unwanted pests such as rodents.

The appearance of spilled waste possesses negative impact on a business or other operations. Conventional trash cans have been improved over the years to make them more user-friendly, sanitary, and hygienic. For example, many trash cans are now provided with a foot pedal, so that a user may step on the foot pedal to open the lid of the trash can, thereby freeing up the user's hands to toss trash, or to change the plastic liner or bag that is used to line the trash can. The problem of washing the trash can still remains.

Accordingly, it is known, as disclosed in Yurko, U.S. Pat. No. 4,721,226, to alter the waste container so that a dispenser box containing liners is inserted into the bottom of the trash container. The dispenser box contains a plurality of flatly folded bags which are retrievable from a slot in the top of the dispenser box. However, such a device requires a waste container specially modified to accept the dispenser box. Further, a portion of the interior space of the waste container is filled and lost to use because of space taken by the dispenser box.

U.S. Pat. No. 5,004,114 shows a garbage can and cover assembly where the cover is threadedly engageable with the can. The cover is retained in close proximity to the can by a pair of hingedly connected arms. One arm is hingedly connected to the side wall of the garbage can, while the second arm is pivotally engaged with a central position on the cover. This pivoted connection permits the unthreading of the cover, while the other hinged connections of the arms permit the cover to be rotated away from the can. This assembly does not function to keep the cover on the can. Rather, the cover and can must rely upon their threaded interconnection. As a result, this complex hinged arrangement would be substantially useless on most garbage cans that do not have threaded inter engagement of the cover and the can.

Therefore, there is a significant need for an object which can create a situation where the trash container liner is located in a manner which will always cause it to be used to line the interior of trash containers and further be oriented such that the trash container liner can also be properly installed in the trash contain.

### SUMMARY

In view of the foregoing, an embodiment herein provides a trash bin with a liner to dump trashes. The trash bin includes a plastic sheet, a tripod stand, one or more liner holding slots and one or more velcros. The plastic sheet is adapted to get folded by a user.

The tripod stand holding slot holds a tripod stand. The tripod stand holds the trash bin in upright position. The one or more liner holding slots lock the liner. The liner covers the trash bin from outside or inside of the trash bin. The one or more velcros that are attached to both sides of the plastic sheet form a cylindrical structure by rolling the plastic sheet. In one embodiment, depending on the use (for e.g., on the beach, in cars), the liner can be used in a free stand form without the tripod stand.

In one embodiment, the trash bin is provided with height adjustment. The height of the trash bin is adjusted by adjusting periphery of top portion of the plastic sheet. The tripod stand is made of one or more legs that are connected with each other using a connector. In another embodiment, the one or more velcros are attached to both sides of the plastic sheet using staples. The trash bin is adapted to get packed in a plastic bag after usage.

In another aspect, an adjustable trash bin with a liner to dump trashes is provided. The adjustable trash bin includes a foldable plastic sheet and one or more velcros. The foldable plastic sheet is adapted to get folded by a user and further includes a tripod stand holding slot and one or more liner holding slots. The tripod stand holding slot holds a tripod stand which further holds the adjustable trash bin in upright position. The one or more liner holding slots lock the liner at the place. The adjustable trash bin is covered by the liner from outside or inside of the adjustable trash bin. The one or more velcros are attached to both sides of the foldable plastic sheet. The one or more velcros form a cylindrical structure by rolling the foldable plastic sheet of the adjustable trash bin. The height of the trash bin is adjusted by adjusting periphery of top portion of the plastic sheet.

In one embodiment, the adjustable trash bin is provided with the tripod stand made of one or more legs. The one or more legs are connected with each other using a connector. In one embodiment, the one or more velcros are attached to both sides of the plastic sheet using staples. The trash bin gets packed in a plastic bag after usage.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof and the embodiments herein include all such modifications.

### BRIEF DESCRIPTION OF THE DRAWINGS

The embodiments herein will be better understood from the following detailed description with reference to the drawings, in which:

FIG. 1A is a perspective view of a trash bin with a tripod stand according to an embodiment herein;

FIG. 1B is a perspective view of the trash bin when the user unrolls the trash bin according to an embodiment herein;

FIG. 1C is a perspective view of the tripod stand, according to an embodiment herein;

FIG. 1D is a perspective view of a trash bin covered with a liner from outside according to an embodiment herein; and

FIG. 1E is a perspective view of a trash bin covered with a liner from inside according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

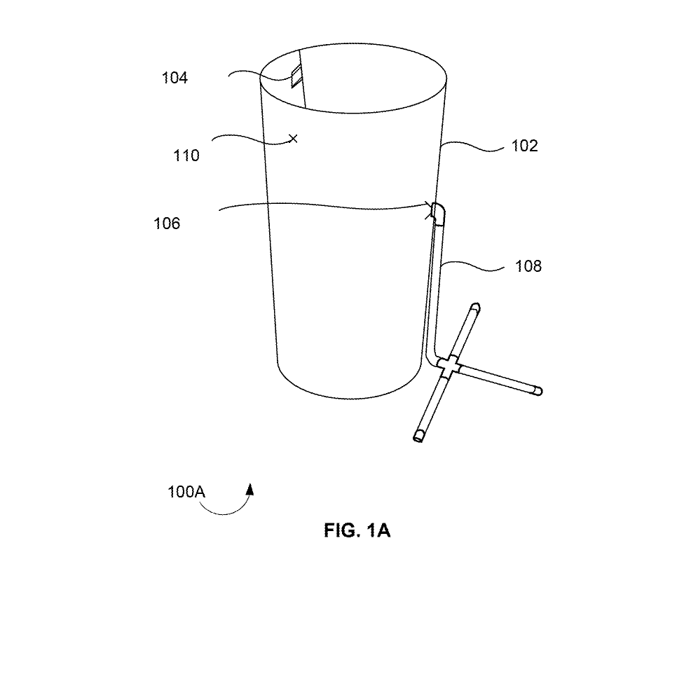

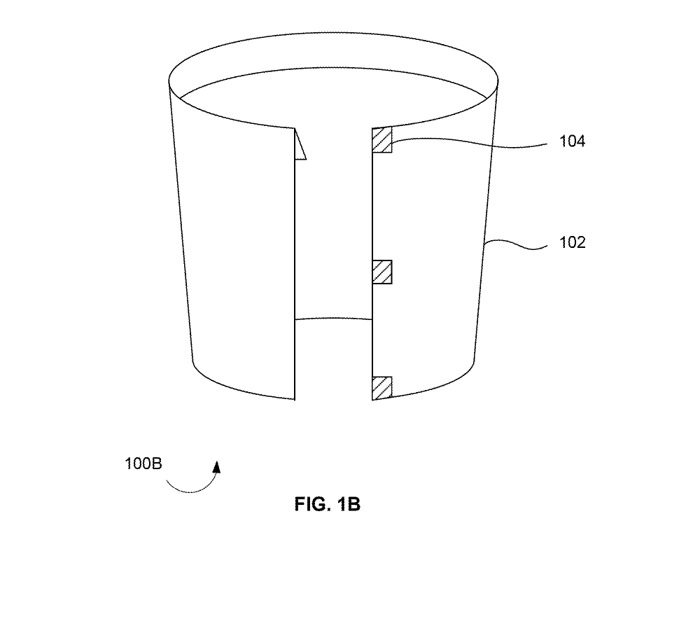

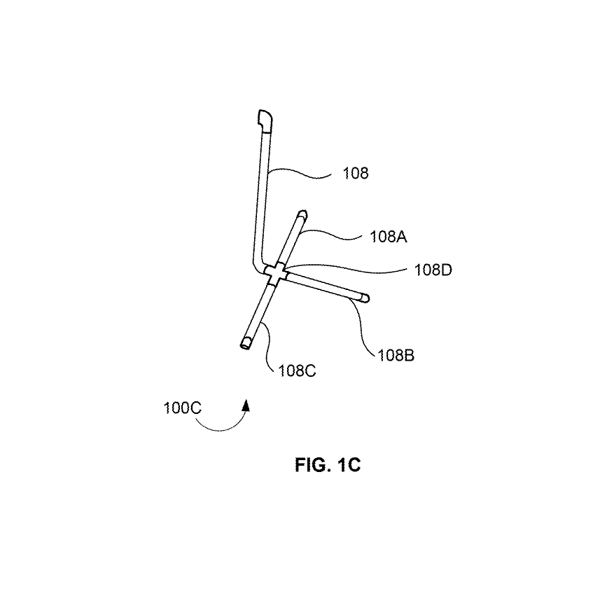

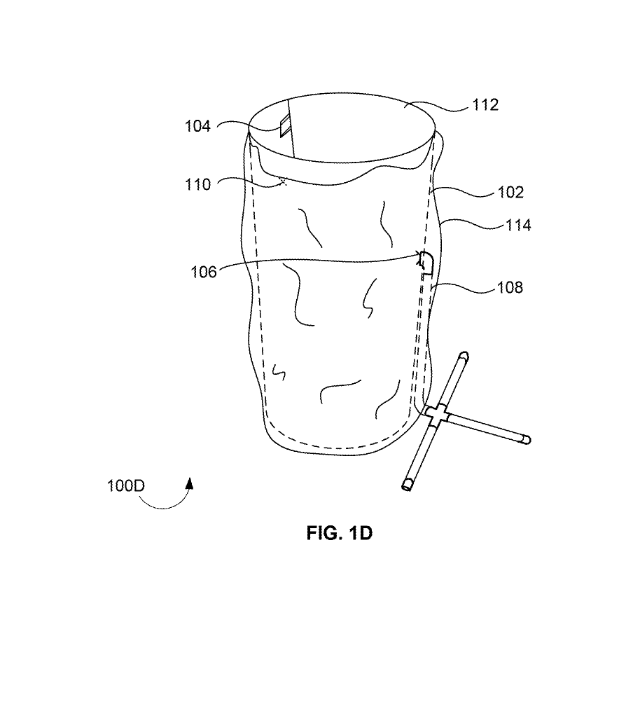

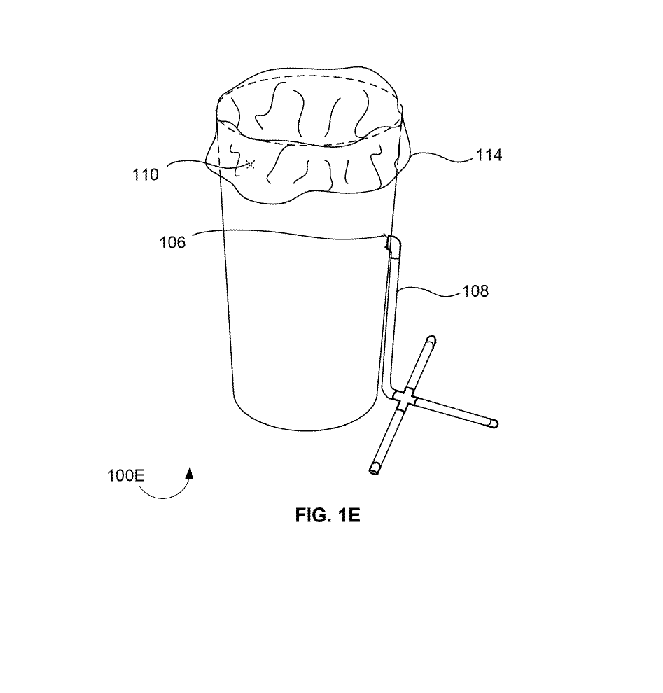

As mentioned, there remains a need for simple and inexpensive trash bin with a liner to dispense the trashes. The embodiments herein achieve this by providing a plastic sheet with multiple velcros at the opposite edges of the plastic sheet to roll and join the edges together. The liner is then mounted on the rolled plastic sheet. Referring now to the drawings, and more particularly to FIGS. 1A through 1E, where similar reference characters denote corresponding features consistently throughout the figures, there are shown preferred embodiments.

FIG. 1A is a perspective view 100A of a trash bin 102 with a tripod stand 108 according to an embodiment herein. The trash bin 102 includes one or more velcros 104, a tripod stand holding slot 106, the tripod stand 108 and one or more liner holding slots 110. The trash bin 102 is made from a plastic sheet. The plastic sheet forms the main body of the trash bin 102. A user rolls the plastic sheet to form the cylindrical structure of the trash bin 102. The one or more velcros 104 is adapted to hold the plastic sheet in cylindrical structure. The tripod stand 108 is coupled to the trash bin 102 by inserting the tripod stand 108 in the tripod stand holding slot 106.

FIG. 1B is a perspective view 100B of the trash bin 102 when the user unrolls the trash bin 102 according to an embodiment herein. The plastic sheet is folded/unfolded from the top portion of the trash bin 102 along with the periphery to adjust the height of the trash bin 102. The one or more velcros 104 are coupled to the opposite edges of the plastic sheet 102. The user rolls the plastic sheet 102 and joins the edges of the plastic sheet 102 using the one or more velcros 104. In an embodiment, the one or more velcros 104 is coupled to the plastic sheet 102 using staples.

FIG. 1C is a perspective view 100C of the tripod stand 108 according to an embodiment herein. The tripod stand 108 includes a first leg 108A, a second leg 108B, a third leg 108C and a connector 108D. The first leg 108A, the second leg 108B and the third leg 108C connects to each other using the connector 108D. In an embodiment, the tripod stand 108 holds the trash bin 102 in an erected position.

FIG. 1D is a perspective view 100D of a trash bin 102 covered with a liner 114 from outside according to an embodiment herein. The trash bin 102 further includes the top portion 112 and the liner 114. The user covers the trash bin 102 with the liner 114 from outside and locks the liner 114 into the one or more liner holding slots 110. The user dumps the trash in the trash bin 102 from the top portion 112 of the trash bin. When the trash bin 102 fills with the trash, the user pulls the tripod stand 108 out of the tripod stand holding slot 106 and lifts the rolled plastic sheet of the trash bin 102 up, leaving behind the liner 114 filled with the trash.

FIG. 1E is a perspective view 100E of a trash bin 102 covered with a liner 114 from inside according to an embodiment herein. The user covers the trash bin 102 with the liner 114 from inside and locks the liner 114 into the one or more liner holding slots 110. The user dumps the trash in the trash bin 102 from the top portion 112 of the trash bin 102. When the trash bin 102 fills with the trash, the user pulls the tripod stand 108 out of the tripod stand holding slot 106 and either lifts the liner 114 up filled with the trash, leaving behind the rolled plastic sheet of the trash bin 102 or lifts the trash bin 102 leaving behind the liner 114 filled with the trash. In one embodiment, the user rolls the plastic sheet of the trash bin 102 after the use and packs the plastic sheet of the trash bin 102 in a plastic bag or nylon bag.

The trash bin contains trashes in the form of solid or liquid waste materials. No one prefers to touch the trash bin while dumping the trashes into the bin or carrying the trash bin to make the trash bin vacant. The trash bin with removable liners provides the user flexibility to change the liner every time whenever the trash bin gets filled. Ease to carry the trash bin from one place to another makes it more convenient for the user. When not in use, the user may pack the trash bin in a bag and when needed, the user may setup the trash bin wherever the user wants in no time.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. The trash bin with a liner to dump trashes, wherein said trash bin comprises:
a plastic sheet that is adapted to get folded by a user, wherein said plastic sheet comprises:
a tripod stand holding slot that is adapted to hold a tripod stand, wherein said tripod stand holds said trash bin in upright position; and
a plurality of liner holding slots that are adapted to lock said liner, wherein said trash bin is covered by said liner from outside or inside of said trash bin; and
a plurality of velcros that are attached to both sides of said plastic sheet, wherein said plurality of velcros are adapted to form a cylindrical structure by rolling said plastic sheet of said trash bin.

2. The trash bin of claim 1, wherein height of said trash bin is adjusted by adjusting periphery of top portion of said plastic sheet.

3. The trash bin of claim 1, wherein said tripod stand is made of a plurality of legs, wherein said plurality of legs are adapted to be connected with each other using a connector.

4. The trash bin of claim 1, wherein said plurality of velcros is attached to both sides of said plastic sheet using staples.

5. The trash bin of claim 1, wherein said trash bin is adapted to get packed in a plastic bag after usage.

6. An adjustable trash bin with a liner to dump trashes, wherein said adjustable trash bin comprises:
a foldable plastic sheet that is adapted to get folded by a user, wherein said foldable plastic sheet comprises:
a tripod stand holding slot that is adapted to hold a tripod stand, wherein said tripod stand holds said adjustable trash bin in upright position; and
a plurality of liner holding slots that is adapted to lock said liner, wherein said adjustable trash bin is covered by said liner from outside or inside of said adjustable trash bin; and
a plurality of velcros that are attached to both sides of said foldable plastic sheet, wherein said plurality of velcros are adapted to form a cylindrical structure by rolling said foldable plastic sheet of said adjustable trash bin, wherein height of said trash bin is adjusted by adjusting periphery of top portion of said plastic sheet.

7. The adjustable trash bin of claim 6, wherein said tripod stand is made of a plurality of legs, wherein said plurality of legs are adapted to be connected with each other using a connector.

8. An adjustable trash bin of claim 6, wherein said plurality of velcros is attached to both sides of said plastic sheet using staples.

9. An adjustable trash bin of claim 6, wherein said trash bin is adapted to get packed in a plastic or nylon bag after usage.
